(19) United States
(12) Patent Application Publication
(10) Pub. No.: US 2014/0297164 A1
(43) Pub. Date: Oct. 2, 2014

(54) STOCHASTIC PRE-IGNITION (SPI) MITIGATION USING AN ADAPTIVE SPI SCALER

(71) Applicant: GM Global Technology Operation LLC, Detroit, MI (US)

(72) Inventors: Craig M. Sawdon, Williamston, MI (US); Kevin M. Luchansky, Sterling Height, MI (US); Kathryn Wolfe, Sterling Heights, MI (US); Frank Garthoff, Bad Duerkheim (DE)

(73) Assignee: GM Global Technologies Operations LLC, Detroit, MI (US)

(21) Appl. No.: 13/893,709

(22) Filed: May 14, 2013

Related U.S. Application Data
(60) Provisional application No. 61/807,045, filed on Apr. 1, 2013.

(51) Int. Cl. F02D 35/02

(52) U.S. Cl. CPC F02D 35/027
USPC 701/111

(57) ABSTRACT

A system includes a control module and a stochastic pre-ignition (SPI) module. The control module controls at least one performance parameter of an engine of a vehicle. The SPI module detects SPI events, determines a scaling factor based on the detected SPI events, and adjusts a limit associated with the at least one performance parameter based on the scaling factor. The control module controls the at least one performance parameter based on the limit.

### CROSS-REFERENCE TO RELATED APPLICATIONS

This application claims the benefit of U.S. Provisional Application No. 61/807,045, filed on Apr. 1, 2013. The disclosure of the above application is incorporated herein by reference in its entirety.

### FIELD

The present disclosure relates to systems and methods for reducing and/or preventing stochastic pre-ignition events in an internal combustion engine.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

An internal combustion engine combusts an air and fuel mixture within engine cylinders to drive pistons and produce drive torque. Airflow into the engine is regulated via a throttle. More specifically, the throttle adjusts throttle area to increase or decrease airflow into the engine. As the throttle area increases, the airflow into the engine increases. Conversely, as the throttle area decreases, the airflow into the engine decreases. A fuel control system adjusts the rate that fuel is injected into the cylinders to provide a desired air/fuel mixture to the cylinders and/or to achieve a desired torque output. Increasing the amount of air and fuel provided to the cylinders increases the torque output of the engine.

In spark-ignition engines, spark initiates combustion of an air/fuel mixture provided to the cylinders. In compression-ignition engines, compression in the cylinders combusts the air/fuel mixture provided to the cylinders. Spark timing and air flow may be the primary mechanisms for adjusting the torque output of spark-ignition engines, while fuel flow may be the primary mechanism for adjusting the torque output of compression-ignition engines.

Boosted engines include a boost device, such as a turbocharger or a supercharger, which provides pressurized air to an intake manifold of an engine. The pressurized air increases the compression ratio of the engine. Accordingly, the torque output of the engine increases for a given amount of air and fuel provided to the cylinders. In this manner, a boost device may be used to increase the torque output of the engine and/or to improve the fuel economy of the engine.

Pre-ignition occurs in spark-ignition engines when an air/fuel mixture in a cylinder is ignited by an ignition source other than spark. Pre-ignition types include, for example only, regular pre-ignition and stochastic pre-ignition. Regular pre-ignition occurs in one or more cylinders on a periodic basis (e.g., once per engine cycle). Conversely, stochastic pre-ignition occurs at random. Regular pre-ignition may repeatedly occur under certain engine operating conditions, while stochastic pre-ignition may be less repeatable.

### SUMMARY

A system includes a control module and a stochastic pre-ignition (SPI) module. The control module controls at least one performance parameter of an engine of a vehicle. The SPI module detects SPI events, determines a scaling factor based on the detected SPI events, and adjusts a limit associated with the at least one performance parameter based on the scaling factor. The control module controls the at least one performance parameter based on the limit.

A method includes controlling at least one performance parameter of an engine of a vehicle, detecting stochastic pre-ignition (SPI) events, determining a scaling factor based on the detected SPI events, and adjusting a limit associated with the at least one performance parameter based on the scaling factor. The controlling the at least one performance parameter includes controlling the at least one performance parameter based on the limit.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example engine system according to the principles of the present disclosure;

FIG. 2 is a functional block diagram of an example engine control module according to the principles of the present disclosure;

FIG. 3 is a functional block diagram of an example stochastic pre-ignition module according to the principles of the present disclosure; and

FIG. 4 illustrates an example stochastic pre-ignition mitigation method according to the principles of the present disclosure.

In the drawings, reference numbers may be reused to identify similar and/or identical elements.

### DETAILED DESCRIPTION

Stochastic pre-ignition (SPI) typically occurs in a boosted engine such as a turbo-charged, spark-ignition direct injection engine. Oil and fuel may enter a cylinder of a boosted engine through mechanisms other than a fuel injector due to a high compression ratio of the engine. For example, oil may enter a cylinder of a boosted engine through a positive crankcase ventilation valve, through an intake manifold, and/or between rings of a piston and walls of the cylinder. Stochastic pre-ignition may occur when the oil and fuel auto-ignites (e.g., in a first engine cycle).

In a next engine cycle (e.g., a second engine cycle following the stochastic pre-ignition in the first engine cycle), the air/fuel mixture in the cylinder is typically cooler since there is less unburned oil and fuel in the cylinder. Therefore stochastic pre-ignition may not occur in the next engine cycle. However, in a third engine cycle, additional oil and fuel may accumulate in the cylinder, and therefore stochastic pre-ignition may occur again. Stochastic pre-ignition may continue to occur in this alternating pattern, yielding engine vibrations that alternate between a low intensity and a high intensity.

Various systems and methods may detect, prevent, and/or mitigate stochastic pre-ignition. For example, stochastic pre-ignition events may be detected based on input from a vibration sensor, such as a knock sensor, that detects vibration in an engine block. Conversely, various engine operating conditions may be monitored to determine whether stochastic pre-ignition is likely to occur. If the engine operating conditions meet one or more predetermined criteria, engine operation may be adjusted to prevent and/or mitigate stochastic pre-ignition. For example only, the engine operation may be adjusted by enriching an air/fuel ratio of an engine, executing multiple fuel injection pulses for each combustion event, and/or advancing fuel injection timing.

Further, if stochastic pre-ignition is detected and/or engine operating conditions indicate that stochastic pre-ignition may occur, one or more stochastic pre-ignition mitigation strategies may be implemented to prevent and/or mitigate stochastic pre-ignition. Example stochastic pre-ignition mitigation strategies include, but are not limited to, applying a boost limit, applying a maximum air per cylinder (APC) limit, applying a torque limit, and/or applying one or more other limits to various engine performance parameters.

Stochastic pre-ignition mitigation systems and methods according to the principles of the present disclosure implement an adaptive SPI scaler (e.g., having a range from 0 to 1) to selectively modify an amount of SPI mitigation applied to engine performance. For example, the scaler may correspond to a multiplier that is adjusted from 0 (i.e., no mitigation) to 1 (i.e., maximum mitigation) based on detected SPI events. For example only, the scaler may be increased in response to an SPI being detected and decreased in response to no SPI being detected (e.g., per cycle or number of cycles, and/or for a predetermined period).

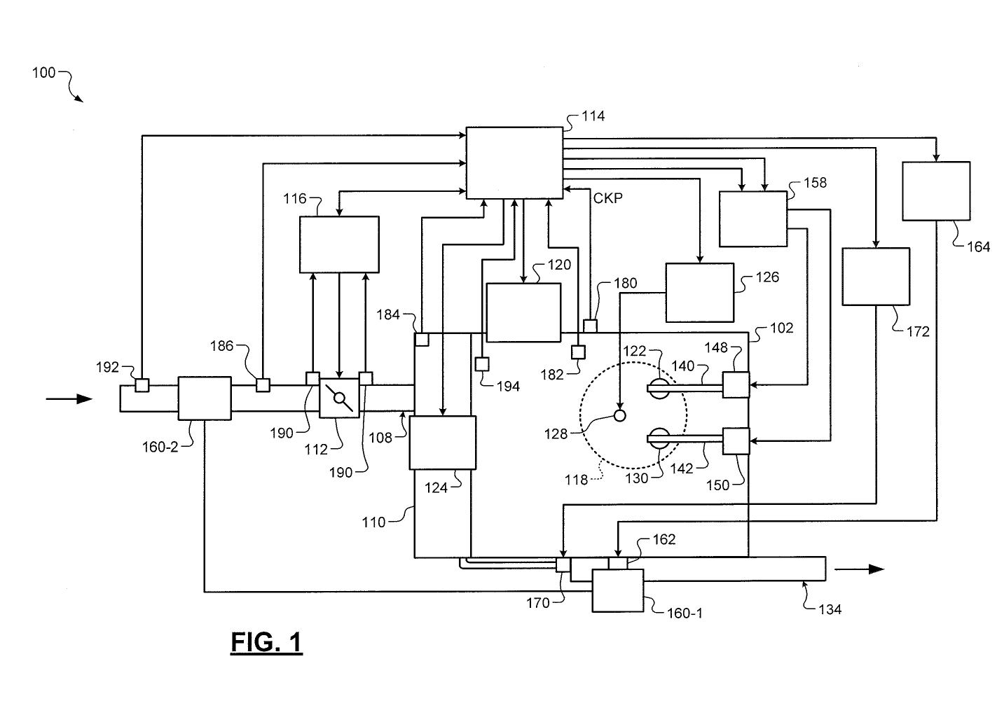

Referring to FIG. 1, an example engine system 100 includes an engine 102 that combusts an air/fuel mixture to produce drive torque for a vehicle based on driver input. Air is drawn into the engine 102 through an intake system 108. The intake system 108 includes an intake manifold 110 and a throttle valve 112. The throttle valve 112 may include a butterfly valve having a rotatable blade. An engine control module (ECM) 114 controls a throttle actuator module 116, which regulates opening of the throttle valve 112 to control the amount of air drawn into the intake manifold 110.

Air from the intake manifold 110 is drawn into cylinders of the engine 102. While the engine 102 may include multiple cylinders, for illustration purposes a single representative cylinder 118 is shown. For example only, the engine 102 may include 2, 3, 4, 5, 6, 8, 10, and/or 12 cylinders. The ECM 114 may instruct a cylinder actuator module 120 to selectively deactivate some of the cylinders, which may improve fuel economy under certain engine operating conditions.

The engine 102 may operate using a four-stroke cycle. The four strokes, described below, are named the intake stroke, the compression stroke, the combustion stroke, and the exhaust stroke. During each revolution of a crankshaft (not shown), two of the four strokes occur within the cylinder 118. Therefore, two crankshaft revolutions are necessary for the cylinder 118 to experience all four of the strokes.

During the intake stroke, air from the intake manifold 110 is drawn into the cylinder 118 through an intake valve 122. The ECM 114 controls a fuel actuator module 124, which regulates fuel injection to achieve a desired air/fuel ratio. Fuel may be injected into the intake manifold 110 at a central location or at multiple locations, such as near the intake valve 122 of each of the cylinders. In various implementations, fuel may be injected directly into the cylinders or into mixing chambers associated with the cylinders. In this regard, the engine 102 may be a spark-ignition direct injection engine. The fuel actuator module 124 may halt injection of fuel to cylinders that are deactivated.

The injected fuel mixes with air and creates an air/fuel mixture in the cylinder 118. During the compression stroke, a piston (not shown) within the cylinder 118 compresses the air/fuel mixture. The engine 102 is depicted as a spark-ignition engine. A spark actuator module 126 energizes a spark plug 128 in the cylinder 118 based on a signal from the ECM 114, which ignites the air/fuel mixture. The timing of the spark may be specified relative to the time when the piston is at its topmost position, referred to as top dead center (TDC).

The spark actuator module 126 may be controlled by a timing signal specifying how far before or after TDC to generate the spark. Because piston position is directly related to crankshaft rotation, operation of the spark actuator module 126 may be synchronized with crankshaft angle. In various implementations, the spark actuator module 126 may halt provision of spark to deactivated cylinders.

Generating the spark may be referred to as a firing event. The spark actuator module 126 may have the ability to vary the timing of the spark for each firing event. The spark actuator module 126 may even be capable of varying the spark timing for a next firing event when the spark timing signal is changed between a last firing event and the next firing event. In various implementations, the engine 102 may include multiple cylinders and the spark actuator module 126 may vary the spark timing relative to TDC by the same amount for all cylinders in the engine 102.

During the combustion stroke, the combustion of the air/fuel mixture drives the piston down, thereby driving the crankshaft. The combustion stroke may be defined as the time between the piston reaching TDC and the time at which the piston returns to bottom dead center (BDC). During the exhaust stroke, the piston begins moving up from BDC and expels the byproducts of combustion through an exhaust valve 130. The byproducts of combustion are exhausted from the vehicle via an exhaust system 134.

The intake valve 122 may be controlled by an intake camshaft 140, while the exhaust valve 130 may be controlled by an exhaust camshaft 142. In various implementations, multiple intake camshafts (including the intake camshaft 140) may control multiple intake valves (including the intake valve 122) for the cylinder 118 and/or may control the intake valves (including the intake valve 122) of multiple banks of cylinders (including the cylinder 118). Similarly, multiple exhaust camshafts (including the exhaust camshaft 142) may control multiple exhaust valves for the cylinder 118 and/or may control exhaust valves (including the exhaust valve 130) for multiple banks of cylinders (including the cylinder 118).

The cylinder actuator module 120 may deactivate the cylinder 118 by disabling opening of the intake valve 122 and/or the exhaust valve 130. In various other implementations, the intake valve 122 and/or the exhaust valve 130 may be controlled by devices other than camshafts, such as electromagnetic actuators.

The time at which the intake valve 122 is opened may be varied with respect to piston TDC by an intake cam phaser 148. The time at which the exhaust valve 130 is opened may be varied with respect to piston TDC by an exhaust cam phaser 150. A phaser actuator module 158 may control the intake cam phaser 148 and the exhaust cam phaser 150 based on signals from the ECM 114. When implemented, variable valve lift (not shown) may also be controlled by the phaser actuator module 158.

The engine system 100 may include a boost device that provides pressurized air to the intake manifold 110. For example, FIG. 1 shows a turbocharger including a hot turbine 160-1 that is powered by hot exhaust gases flowing through the exhaust system 134. The turbocharger also includes a cold air compressor 160-2, driven by the turbine 160-1, that compresses air leading into the throttle valve 112. In various implementations, a supercharger (not shown), driven by the crankshaft, may compress air from the throttle valve 112 and deliver the compressed air to the intake manifold 110.

A wastegate 162 may allow exhaust to bypass the turbine 160-1, thereby reducing the boost (the amount of intake air compression) of the turbocharger. The ECM 114 may control the turbocharger via a boost actuator module 164. The boost actuator module 164 may modulate the boost of the turbocharger by controlling the position of the wastegate 162. In various implementations, multiple turbochargers may be controlled by the boost actuator module 164. The turbocharger may have variable geometry, which may be controlled by the boost actuator module 164.

An intercooler (not shown) may dissipate some of the heat contained in the compressed air charge, which is generated as the air is compressed. The compressed air charge may also have absorbed heat from components of the exhaust system 134. Although shown separated for purposes of illustration, the turbine 160-1 and the compressor 160-2 may be attached to each other, placing intake air in close proximity to hot exhaust.

In the example shown, the engine system 100 includes an exhaust gas recirculation (EGR) valve 170 that selectively redirects exhaust gas back to the intake manifold 110. The EGR valve 170 may be located upstream of the turbocharger's turbine 160-1. The EGR valve 170 may be controlled by an EGR actuator module 172.

The position of the crankshaft may be measured using a crankshaft position (CKP) sensor 180. The temperature of the engine coolant may be measured using an engine coolant temperature (ECT) sensor 182. The ECT sensor 182 may be located within the engine 102 or at other locations where the coolant is circulated, such as a radiator (not shown).

The pressure within the intake manifold 110 may be measured using a manifold absolute pressure (MAP) sensor 184. In various implementations, engine vacuum, which is the difference between ambient air pressure and the pressure within the intake manifold 110, may be measured. The mass flow rate of air flowing into the intake manifold 110 may be measured using a mass air flow (MAF) sensor 186. In various implementations, the MAF sensor 186 may be located in a housing that also includes the throttle valve 112.

The throttle actuator module 116 may monitor the position of the throttle valve 112 using one or more throttle position sensors (TPS) 190. The ambient temperature of air being drawn into the engine 102 may be measured using an intake air temperature (IAT) sensor 192. The vibration of an engine block in the engine 102 may be measured using an engine block vibration (EBV) sensor 194 such as a knock sensor including piezoelectric material that outputs a voltage in proportion to vibration. In one example, the engine system 100 may include one vibration sensor for each bank of cylinders.

The ECM 114 may use signals from the sensors to make control decisions for the engine system 100. In one example, the ECM 114 detects stochastic pre-ignition based on engine vibration and adjusts engine operation when stochastic pre-ignition is detected. The ECM 114 determines a vibration intensity of each engine cycle (e.g., 720 degrees of crankshaft rotation) based on input from the EBV sensor 194. For example, the ECM 114 may detect stochastic pre-ignition when the vibration intensity repeats a pattern of alternating between a high intensity (e.g., an intensity of knock) and a low intensity (e.g., an intensity of background vibration) a predetermined number of times (e.g., 2 times). The ECM 114 may detect stochastic pre-ignition when the vibration intensity is very high (e.g., 3 to 5 times the intensity of knock) for a single engine cycle. In one example, the ECM 114 may enrich an air/fuel ratio of the engine 102 when the engine 102 is operating within a predetermined speed and load range in which the engine 102 is susceptible to stochastic pre-ignition.

Further, if stochastic pre-ignition is detected and/or engine operating conditions indicate that stochastic pre-ignition may occur, the ECM 114 may implement one or more stochastic pre-ignition mitigation strategies to prevent and/or mitigate stochastic pre-ignition. Example stochastic pre-ignition mitigation strategies include, but are not limited to, applying a boost limit, applying a maximum air per cylinder (APC) limit, applying a torque limit, and/or applying one or more other limits to various engine performance parameters. The ECM 114 applies an adaptive SPI scaler (e.g., having a range from 0 to 1) to selectively modify an amount of SPI mitigation applied to engine performance.

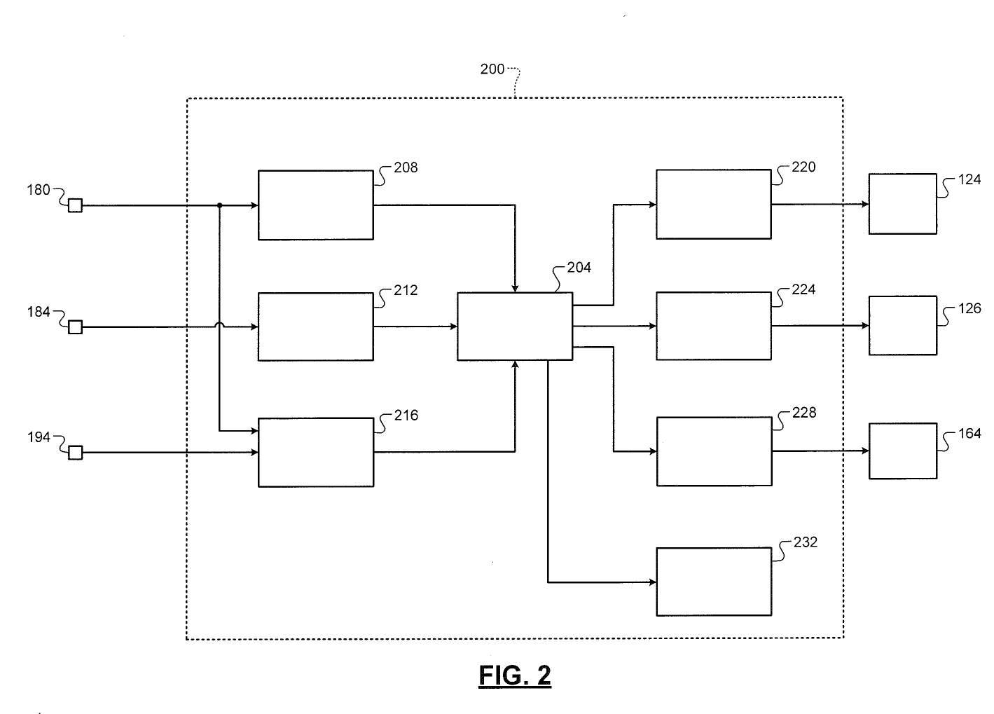

Referring to FIG. 2, an example ECM 200 configured to detect, prevent, and/or mitigate SPI includes an SPI module 204. The SPI module 204 detects SPI events and controls, according to the adaptive SPI scaler, one or more engine performance parameters to prevent and/or mitigate SPI.

For example only, the ECM 200 may also include an engine speed module 208, an engine load module 212, and a vibration intensity module 216. The engine speed module 208 determines engine speed. The engine speed module 208 may determine the engine speed based on input from the CKP sensor 180. The engine speed module 208 may determine the engine speed based on an amount of crankshaft rotation between tooth detections and the corresponding period. The engine speed module 208 outputs the engine speed.

The engine load module 212 determines engine load. The engine load module 212 may determine the engine load based on input from the MAP sensor 184. In various implementations, the pressure within the intake manifold 110 may be used as an approximation of engine load. The engine load module 212 outputs the engine load and/or the manifold pressure.

The vibration intensity module 216 determines a vibration intensity (e.g., a single, unitless value) for each engine cycle based on input from the EBV sensor 194. In one example, the vibration intensity module 216 generates a spectral density of the input from the EBV sensor 194 using a fast Fourier transform. The vibration intensity module 216 may generate a spectral density for each cylinder based on input received from the EBV sensor 194 during a predetermined range of crankshaft rotation that includes TDC (e.g., from TDC to 70 degrees after TDC). The vibration intensity module 216 may determine when the crankshaft position corresponds to the predetermined range of crankshaft rotation based on input from the CKP sensor 180.

The vibration intensity module 216 may aggregate the spectral densities for each cylinder in the engine 102 over an engine cycle to yield a single spectral density for the engine cycle. For example, the spectral densities may include frequency bins having a predetermined width (e.g., 390 Hertz), and the vibration intensity module 216 may sum intensity values of corresponding frequency bins from the spectral densities. For each frequency bin of a spectral density, a maximum value of the frequency bin or an average value across the frequency bin may be selected and added to the maximum or average values of the corresponding frequency bin of the other spectral densities.

The vibration intensity module 216 may determine the vibration intensity of an engine cycle based on a maximum value or an average value of the spectral density for the engine cycle. For example, the vibration intensity module 216 may determine the vibration intensity of an engine cycle by determining the maximum value or the average value of the intensity values from each of the frequency bins in the spectral density. The vibration intensity module 216 outputs the vibration intensity of each engine cycle.

In some example implementations, the SPI module 204 may detect stochastic pre-ignition (e.g., stochastic pre-ignition events) based on the vibration intensity. The SPI module 204 may detect stochastic pre-ignition when the vibration intensity satisfies a predetermined pattern a predetermined number of times (e.g., 2 times) consecutively. The vibration intensity may satisfy the predetermined pattern when the vibration intensity of one engine cycle is less than a first threshold (e.g., 5) and the vibration intensity of the next engine cycle is greater than a second threshold (e.g., 15). The second threshold is greater than the first threshold. A vibration intensity less than the first threshold corresponds to an intensity of normal combustion. A vibration intensity greater than the second threshold corresponds to an intensity of engine knock.

The SPI module 204 may detect stochastic pre-ignition when the vibration intensity of a single engine cycle is greater than a third threshold (e.g., 30). The third threshold is greater than the second threshold. A vibration intensity greater than the third threshold corresponds to an intensity that is three to five times greater than the intensity of engine knock. The SPI module 204 may determine the first, second, and third thresholds based on the engine speed and the engine load using, for example, a lookup table. The SPI module 204 may increase the first, second, and third thresholds as the engine speed and the engine load increase to prevent a false detection of stochastic pre-ignition. The SPI detection module 208 outputs a signal indicating whether stochastic pre-ignition is detected.

In other example implementations, the SPI module 204 may detect stochastic pre-ignition, and/or may determine whether operating conditions of the engine 102 satisfy predetermined criteria associated with stochastic pre-ignition. The operating conditions may include a first condition that satisfies the predetermined criteria when the engine speed is greater than or equal to a predetermined speed (e.g., 1500 revolutions per minute). The operating conditions may include a second condition that satisfies the predetermined criteria when the engine load is greater than or equal to a predetermined load and/or when the manifold pressure is greater than or equal to a predetermined pressure (e.g., 60 kilopascals). The stochastic pre-ignition module 204 may output a signal indicating whether the operating conditions of the engine 102 satisfy the predetermined criteria.

For example only, the ECM 200 may include a fuel control module 220, a spark control module 224, and a boost control module 228. The fuel control module 220 sends a signal to the fuel actuator module 124 to control fuel injection into cylinders of the engine 102. The spark control module 224 sends a signal to the spark actuator module 126 to control spark generation in cylinders of the engine 102. The boost control module 228 sends a signal the boost actuator module 164 to control boost in the engine 102.

The fuel control module 220 may adjust fuel injection in the engine 102 when the operating conditions of the engine 102 satisfy the predetermined criteria in order to prevent stochastic pre-ignition. For example, the fuel control module 208 may enrich an air/fuel ratio of the engine 102, execute multiple (e.g., two or more) fuel injection pulses for each combustion event, and/or advance fuel injection timing of the engine 102 when the predetermined criteria is satisfied. The fuel control module 220 may enrich the air/fuel ratio of the engine 102 by adjusting the air/fuel ratio from a normal air/fuel ratio (e.g., 14.7 to 1) to a rich air/fuel ratio (e.g., an air/fuel ratio between 10 to 1 and 12 to 1).

When executing multiple fuel injection pulses for each combustion event, the fuel control module 220 may ensure that each pulse of fuel is injected into a cylinder before spark is generated in the cylinder. When advancing fuel injection timing, the fuel control module 220 may advance the start of fuel injection by a predetermined amount relative to a normal start of fuel injection. For example, fuel injection may normally start at a crank angle between 40 and 50 degrees before TDC, and the fuel control module 220 may advance the start of fuel injection by 40 to 50 degrees relative to the normal start of fuel injection. Thus, the advanced fuel injection may start at a crank angle between 80 and 100 degrees before TDC.

The spark control module 224 may advance spark timing in the engine 102 and/or the boost control module 228 may reduce boost in the engine 102 when the operating conditions of the engine 102 satisfy the predetermined criteria. Reducing boost in the engine 102 may prevent stochastic pre-ignition in the engine 102. The boost control module 228 may reduce boost in the engine 102 when the spark timing in the engine 102 is advanced to ensure that the advanced spark timing does not cause the torque output of the engine 102 to overshoot a driver torque request.

Although example stochastic pre-ignition detection and prevention are described above, the ECM 200 according to the principles of the present disclosure may implement other suitable systems and methods for preventing and/or detecting stochastic pre-ignition.

The ECM 200 also implements stochastic pre-ignition mitigation systems and methods, and implements an adaptive SPI scaler according to the principles of the present disclosure. For example, the ECM 200 may control one or more modules and/or actuators of the engine system 100 to limit engine performance parameters including, but not limited to, boost (e.g., by controlling the boost control module 228 to apply a boost limit), a maximum air per cylinder (e.g., by controlling valve actuation or another method to apply an APC limit), and/or torque (e.g., by controlling a torque control module 232 to apply a torque limit). The ECM 200 implements stochastic pre-ignition mitigation according to the adapative SPI scaler (i.e., a scaling factor).

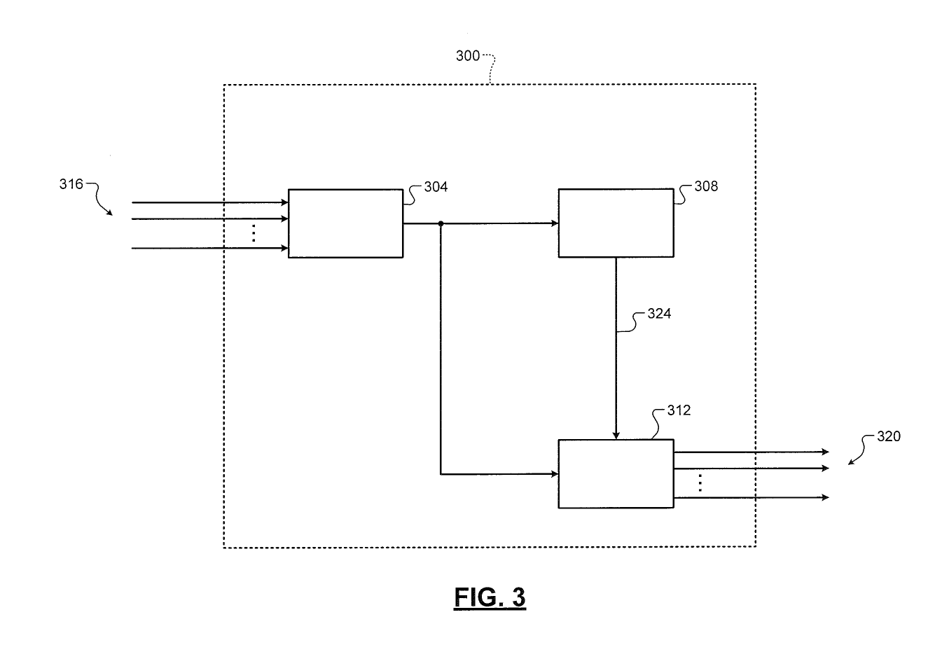

Referring now to FIG. 3, an example stochastic pre-ignition module 300 includes an SPI detection module 304, a scaling factor determination module 308, and an SPI prevention/mitigation module (referred to hereinafter as an SPI mitigation module) 312. The SPI detection module 304 detects SPI events based on one or more inputs 316 (e.g., in response to vibration intensity as described above or another suitable detection method). The SPI detection module 304 communicates an indication that an SPI event was detected to the SPI mitigation module 312. For example, the SPI mitigation module 312 selectively implements SPI mitigation strategies based on whether the SPI detection module 304 indicates that an SPI event was detected. For example only, the SPI mitigation module 312 may activate an SPI mitigation strategy if an SPI event was detected within a predetermined period. The SPI detection module 304 also communicates an indication to the scaling factor determination module 308 each time an SPI event is detected.

The SPI mitigation module 312 applies one or more limits to respective engine performance parameters such as boost, maximum APC, torque, etc. as described above, and outputs one or more limit signals 320 to respective modules and/or actuators accordingly. For example, the limit for an engine performance parameter may include an offset to a maximum value. For example only, the engine performance parameter may have a maximum value (e.g., a default limit) of X. Conversely, the offset associated with a limit for the engine performance parameter may correspond to Y. Accordingly, when a limit is applied to the engine performance parameter, an adjusted maximum value for the performance parameter may correspond to the maximum value X reduced by the offset Y (i.e., X−Y). Further, the offset Y may vary based on other engine performance parameters. For example, the offset Y may vary according to engine speed, temperature, vehicle speed, etc. For example only, the offset Y may increase as engine speed increases as shown below in table 1.

TABLE 1

| | Offset |
|---|---|
| RPM | (Boost/APC/Torque) |
| 1000 | Y |
| 1500 | Y + A |
| 2000 | Y + B |
| 2500 | Y + C |
| 3000 | Y + D |
| 3500 | Y + E |
| — | — |
| — | — |
| — | — |
| — | — |
| — | — |

The SPI mitigation module 312 receives a scaling factor 324 from the scaling factor determination module 308 and applies the scaling factor to the offset Y. For example, the scaling factor 324 may have a range from 0 to 1 to selectively modify an amount of SPI mitigation (i.e., the value of the offset Y) applied to the engine performance parameter. In other words, the scaling factor 324 may correspond to a multiplier that is adjusted from 0 (i.e., no mitigation) to 1 (i.e., maximum mitigation) based on detected SPI events. As such, if the scaling factor 324 is 0, then the offset is 0, and no limit is applied to the maximum value of the corresponding engine performance parameter. Conversely, the scaling factor 324 is 1, then the offset is Y (i.e., a full value of the offset Y), and the maximum value of the corresponding engine performance parameter is reduced by the offset Y. Further, if the scaling factor 324 is somewhere between 0 and 1 (e.g., 0.5), then the offset is a nonzero fraction of Y (e.g., 0.5*Y). In this manner, the limits applied to the respective engine performance parameters for SPI mitigation may vary according to specific engine conditions (e.g., engine speed, temperature, vehicle speed, etc.).

As shown, the scaling factor 324 is provided from the scaling factor determination module 308 to the SPI mitigation module 312. In other words, the scaling factor is applied to the offset Y at the SPI mitigation module 312. In other implementations, the scaling factor 324 may be applied to the offset Y at, for example, the scaling factor determination module 308 or another component of the SPI module 300. Accordingly, the adjusted (i.e., scaled with the scaling factor 324) offset Y is provided to the SPI mitigation module 312.

In some implementations, application of the scaling factor 324 may be selectively enabled or disabled based on one or more other engine performance parameters. For example, if engine speed or MAP is above or below a threshold, the scaling factor 324 may be disregarded and the offset Y applied without the scaling factor (or the scaling factor may be disregarded and no offset applied). In other words, the limit may be applied to a respective engine performance parameter according to the maximum offset Y (or no offset at all) regardless of the scaling factor 324 if engine speed or MAP is above or below the threshold.

The scaling factor determination module 308 outputs, and adjusts, the scaling factor 324 based on SPI events detected by the SPI detection module 304. For example, the scaling factor determination module 308 selectively increases and decreases the scaling factor 324. For example only, the scaling factor determination module 308 may increase the scaling factor 324 in response to an SPI event being detected and decreased in response to no SPI event being detected (e.g., per cycle or number of cycles, and/or for a predetermined period).

In an example implementation, a default value of the scaling factor 324 (e.g., the offset Y) may be 0 (e.g., upon vehicle startup, in response to a reset condition, etc.). Or, the scaling factor 324 may retain a value even when the vehicle is off. Accordingly, at vehicle startup, the scaling factor 324 retains the same value as when the vehicle was turned off. Further, the value of the scaling factor 324 may be reset (e.g., to 0 or another default value) if the vehicle is off for at least a predetermined period.

The scaling factor determination module 308 increases the scaling factor 324 in response to detected SPI events. For example, the scaling factor determination module 308 may increase the scaling factor 324 (e.g., by a fixed amount such as 0.01, 0.05, 0.1, etc.) each time an SPI event is detected. Conversely, the scaling factor determination module 308 decreases the scaling factor 324 when SPI events are not detected. For example, the scaling factor determination module 308 may decrease the scaling factor 324 when a predetermined period (e.g., 5 seconds, 10 seconds, 1 minute, etc) and/or a predetermined number of ignition cycles passes without an SPI event being detected.

The amount that the scaling factor 324 is increased (i.e., an increase rate) may be different from the amount that the scaling factor is decreased (i.e., a decrease rate). For example, the increase rate may be greater than the decrease rate. In this manner, the scaling factor 324 may be increased to a maximum of 1 in response to detected SPI events at a relatively greater rate than the scaling factor 324 is decreased (e.g., from 1 or another value to 0). In other words, in response to SPI events being detected, the scaling factor 324 may be increased relatively quickly from 0 to 1. Conversely, if SPI events are no longer being detected, the scaling factor 324 may be decreased relatively slowly from 1 to 0.

In some implementations, the increase rate may be adjusted (e.g., exponentially). For example, the increase rate may be relatively small if a single SPI event is detected and may be adjusted upward if additional SPI events are detected. Accordingly, the increase rate may be greater as the scaling factor 324 increases. Conversely, the decrease rate may be adjusted in a similar manner. For example, the decrease rate may be relatively small after a first predetermined period without an SPI event being detected, but may be adjusted upward after subsequent periods without an SPI event being detected.

Further, the amount that the scaling factor 324 is increased or decreased may vary based on other engine performance parameters such as engine speed. For example, if the engine speed is less than 1000 RPM, a starting increase rate may be a first value. If the engine speed is between 1000 RPM and 1500 RPM, the starting increase rate may be a second value greater than the first value. If the engine speed is between 1500 RPM and 2000 RPM, the starting increase rate may be a third value greater than the second value. A starting decrease rate may be adjusted downward in a similar manner. Further, although engine speed is provided as an example engine performance parameter, other engine performance parameters may affect the increase and decrease rates, the offset value, etc. For example only, MAP is another parameter that may be considered.

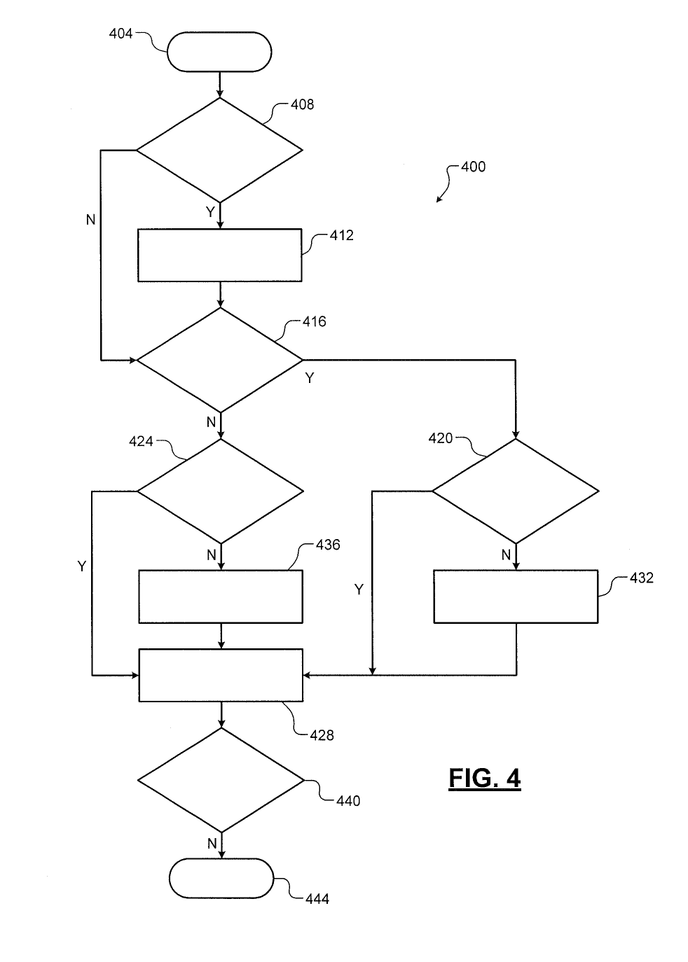

Referring now to FIG. 4, an example stochastic pre-ignition mitigation method 400 begins at 404. At 408, the method 400 determines whether the vehicle (or engine) has been off for a predetermined period. If true, the method 400 continues to 416. If false, the method 400 continues to 412. At 412, the method 400 resets the scaling factor (e.g., to 0). At 416, the method 400 determines whether an SPI event was detected. If true, the method 400 continues to 420. If false, the method 400 continues to 424. At 420, the method 400 determines whether the scaling factor is 1. If true, the method 400 continues to 428. If false, the method 400 continues to 432. At 432, the method 400 increases the scaling factor as described, for example only, with respect to FIG. 3.

At 424, the method 400 determines whether the scaling factor is 0. If true, the method 400 continues to 428. If false, the method 400 continues to 436. At 436, the method 400 decreases the scaling factor as described, for example only, with respect to FIG. 3. At 428, the method 400 applies the scaling factor to, for example, an offset to be applied to a limit associated with an engine performance parameter. At 440, the method 400 determines whether the engine of the vehicle is on. If true, the method 400 continues to 420. If false, the method 400 ends at 444.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

In this application, including the definitions below, the term module may be replaced with the term circuit. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory. Non-limiting examples of a non-transitory tangible computer readable medium include nonvolatile memory, volatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

What is claimed is:

1. A system comprising:
a control module that controls at least one performance parameter of an engine of a vehicle; and
a stochastic pre-ignition (SPI) module that detects SPI events, determines a scaling factor based on the detected SPI events, and adjusts a limit associated with the at least one performance parameter based on the scaling factor,
wherein the control module controls the at least one performance parameter based on the limit.

2. The system of claim 1, wherein the SPI module increases the scaling factor when an SPI event is detected and decreases the scaling factor when an SPI event is not detected.

3. The system of claim 2, wherein the SPI module decreases the scaling factor when an SPI event is not detected for at least one of a predetermined period and a predetermined number of ignition cycles of the engine.

4. The system of claim 2, wherein the SPI module increases the scaling factor at a first rate and decreases the scaling factor at a second rate that is less than the first rate.

5. The system of claim 2, wherein the SPI module increases and decreases the scaling factor further based on at least one of an engine speed and a manifold absolute pressure.

6. The system of claim 1 wherein the SPI module determines the scaling factor based on at least one of an engine speed and a manifold absolute pressure.

7. The system of claim 1 wherein the limit corresponds to an offset from a maximum value of the at least one performance parameter.

8. The system of claim 1, wherein the SPI module multiplies the scaling factor by the offset.

9. The system of claim 1, wherein the at least one performance parameter includes at least one of boost, maximum air per cylinder, and torque.

10. A method comprising:
controlling at least one performance parameter of an engine of a vehicle;
detecting stochastic pre-ignition (SPI) events;
determining a scaling factor based on the detected SPI events; and
adjusting a limit associated with the at least one performance parameter based on the scaling factor,
wherein the controlling the at least one performance parameter includes controlling the at least one performance parameter based on the limit.

11. The method of claim 10, further comprising increasing the scaling factor when an SPI event is detected and decreasing the scaling factor when an SPI event is not detected.

12. The method of claim 11, further comprising decreasing the scaling factor when an SPI event is not detected for at least one of a predetermined period and a predetermined number of ignition cycles of the engine.

13. The method of claim 11, further comprising increasing the scaling factor at a first rate and decreasing the scaling factor at a second rate that is less than the first rate.

14. The method of claim 11, further comprising increasing and decreasing the scaling factor further based on at least one of an engine speed and a manifold absolute pressure.

15. The method of claim 10 further comprising determining the scaling factor based on at least one of an engine speed and a manifold absolute pressure.

16. The method of claim 10 wherein the limit corresponds to an offset from a maximum value of the at least one performance parameter.

17. The method of claim 10, further comprising multiplying the scaling factor by the offset.

18. The method of claim 10, wherein the at least one performance parameter includes at least one of boost, maximum air per cylinder, and torque.
